(19) United States
(12) Patent Application Publication
(10) Pub. No.: US 2024/0317260 A1
(43) Pub. Date: Sep. 26, 2024

(54) PERCEPTION SYSTEM WITH AN OCCUPIED SPACE AND FREE SPACE CLASSIFICATION

(71) Applicant: GM Cruise Holdings LLC, San Francisco, CA (US)

(72) Inventor: Burkay Donderici, Burlingame, CA (US)

(21) Appl. No.: 18/186,683

(22) Filed: Mar. 20, 2023

(51) Int. Cl. B60W 60/00

(52) U.S. Cl. CPC B60W 60/0015; B60W 2556/25; B60W 2556/35

(57) ABSTRACT

Systems and techniques are provided for utilizing occupied space and free space metrics for object detections of a perception system. An example method can include generating an occupancy-space probability and a free-space probability for each cell in a grid map representing a scene. The occupancy-space and the free-space probabilities can be based on sensor data captured by a first sensor of an autonomous vehicle (AV) in the scene. The example method can include receiving object detection(s) in the scene based on the sensor data captured by a second sensor of the AV in the scene; comparing, for each cell in the grid map, the object detection(s) in the scene against the occupancy-space and free-space probabilities in the scene; and identifying a missing object or a non-existent object in the scene based on the comparison of the object detection(s) against the occupancy-space and free-space probabilities. System and machine-readable media are also provided.

### TECHNICAL FIELD

The present disclosure generally relates to a perception system. For example, aspects of the disclosure relate to systems and techniques for utilizing occupied space and/or free space metrics to improve object detections of a perception system.

### BACKGROUND

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, an image sensor can be used to capture frames (e.g., video frames and/or still pictures/images) depicting a target(s) from any electronic device equipped with an image sensor. As another example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 is a diagram illustrating an example pipeline for utilizing occupied space and free space metrics for object detections, according to some examples of the present disclosure;

FIG. 3 is a flowchart illustrating an example process for utilizing occupied space and free space metrics for object detections, according to some examples of the present disclosure;

FIG. 4 is a diagram illustrating an example grid map representing a scene captured by sensors, according to some examples of the present disclosure;

FIG. 5 is a flowchart illustrating an example process for utilizing occupied space and free space metrics for object detections, according to some examples of the present disclosure; and

FIG. 6 illustrates an example processor-based system with which some aspects of the subject technology can be implemented.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, sensors are commonly integrated into a wide array of systems and electronic devices. The sensors allow users to obtain sensor data that measures, describes, and/or depicts one or more aspects of a target such as an object, a scene, a person, and/or any other targets. For example, an image sensor can be used to capture frames (e.g., video frames and/or still pictures/images) depicting a target(s) from any electronic device equipped with an image sensor. As another example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR. The sensors can be implemented by a variety of systems for various purposes.

For example, autonomous vehicles (AVs) generally implement numerous sensors for various AV operations, such as a camera sensor, a LIDAR sensor, a radio detection and ranging (RADAR) sensor, an inertial measurement unit (IMU), an acoustic sensor (e.g., sound navigation and ranging (SONAR), microphone, etc.), and/or a global navigation satellite system (GNSS) and/or global positioning system (GPS) receiver, amongst others. The AVs can use the sensors to collect sensor data that the AVs can use for operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc. The sensors can provide the sensor data to an internal computing system of the AV, which can use the sensor data to control an electrical and/or mechanical system of the AV, such as a vehicle propulsion system, a braking system, and/or a steering system, for example.

Various sensors implemented by an AV may obtain sensor data (e.g., measurements, image data, and/or other sensor data), which can be used to identify and/or classify objects in the same scene. For example, different sensors and/or sensor modalities can be used to capture aspects of the same scene. As such, a perception system of an AV, based on the sensor data captured by multiple sensors and/or sensor modalities, may identify/detect objects in the environment through a combination of sensor fusion and machine learning algorithms so that these object detections can be used by the AV to make decisions about its environment and to navigate through the environment safely.

A perception system of an AV typically operates based on the concept of object detection. For example, a perception system of an AV can collect sensor data from various sensors and analyze the sensor data to extract relevant features that can help object detection (e.g., identify objects of interest). The object detection information from different sensors and object detection algorithms can be fused to generate a more comprehensive understanding of the surrounding environment. However, some sensor data may not be easily translated into a detection due to an uncertainty of the presence and/or absence of an object in the scene. Also, a lack of exchange of information relating to a probabilistic representation of the presence and/or absence of an object between sensors and/or sensor modalities can result in a conflicting detection output from different sensors.

Systems, apparatuses, processes (also referred to as methods), and computer-readable media (collectively referred to as “systems and techniques”) are described herein for utilizing occupied space and free space metrics for object detections of a perception system. In some examples, the systems and techniques described herein can generate, in addition to object detection(s), occupied space (or occupancy space) probability and free space (or drivable space) probability based on sensor data collected by AV sensor(s). For example, each sensor and/or sensor modality can generate object detection(s), occupied space probability, and free space probability. A perception system can utilize the object detection(s) and occupied space and free space metrics from different sensors and/or sensor modalities to determine any inconsistencies. The systems and techniques described herein can determine conflicting output with respect to object detection(s), occupied space and/or free space metrics (e.g., probability) between sensor data captured by different sensors and/or sensor modalities.

In some cases, the systems and techniques described herein can determine if any object is missing or non-existing/non-existent based on the comparison between the first output based on sensor data from a first sensor and the second output based on sensor data from a second sensor. For example, if any detection that is identified based on sensor data that is captured by a first sensor (e.g., a LiDAR sensor) conflicts with an occupied space probability and/or free space probability generated based on sensor data that is captured by a second sensor (e.g., a camera sensor), a perception system can use the conflicting information to determine a missing object and/or non-existent object. As follows, the systems and techniques described herein can determine a proper remedial action with respect to a missing object and/or non-existent object. By facilitating the exchange of information relating to a probabilistic representation of an occupied space and/or free space between different sensors and/or sensor modalities, the systems and techniques described herein can improve the perception (e.g., object detection) of a perception system.

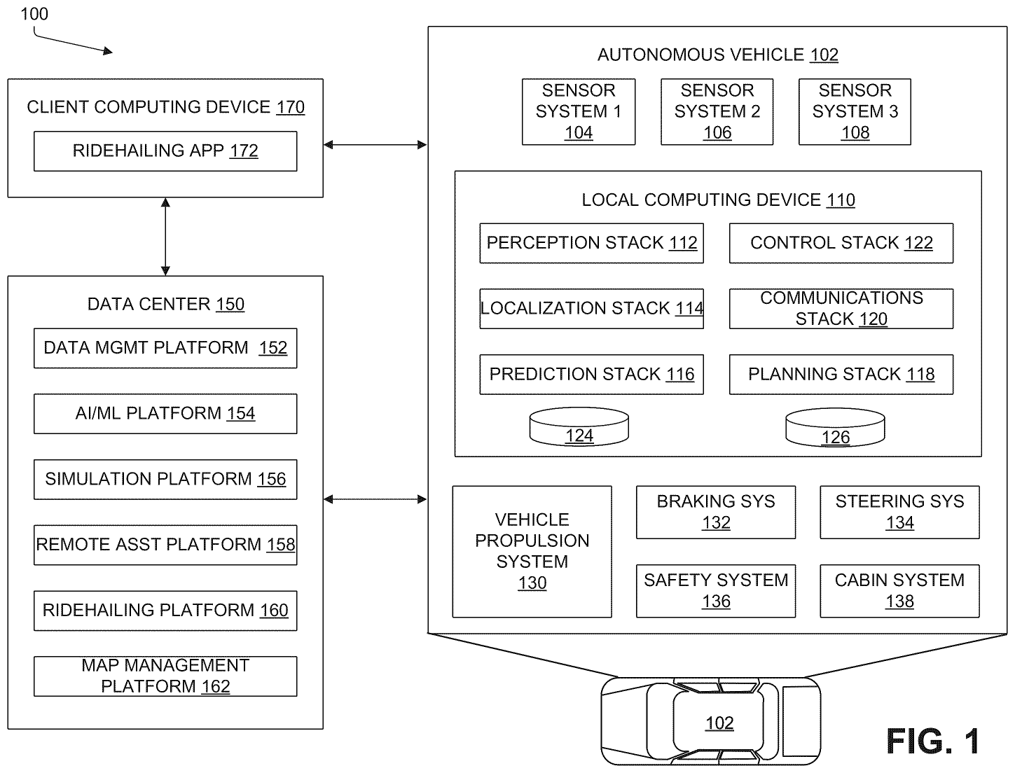

Examples of the systems and techniques described herein are illustrated in FIG. 1 through FIG. 6 and described below.

In some examples, the systems and techniques described herein for utilizing occupied space and free space metrics for object detections can be implemented by an AV in an AV environment. FIG. 1 is a diagram illustrating an example AV environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 (e.g., client application) to enable passengers to view the AV 102 in transit en route to a pick-up or drop-off location, and so on.

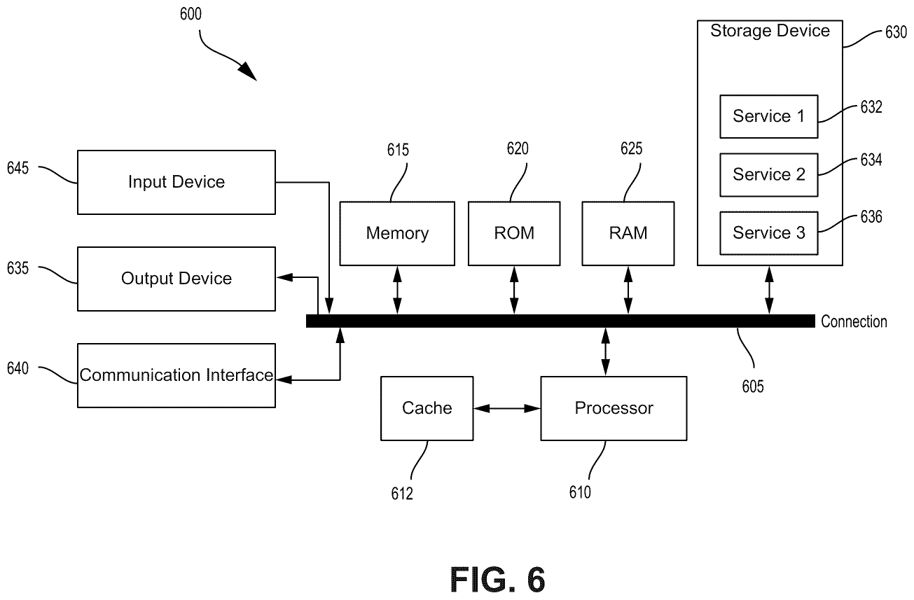

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

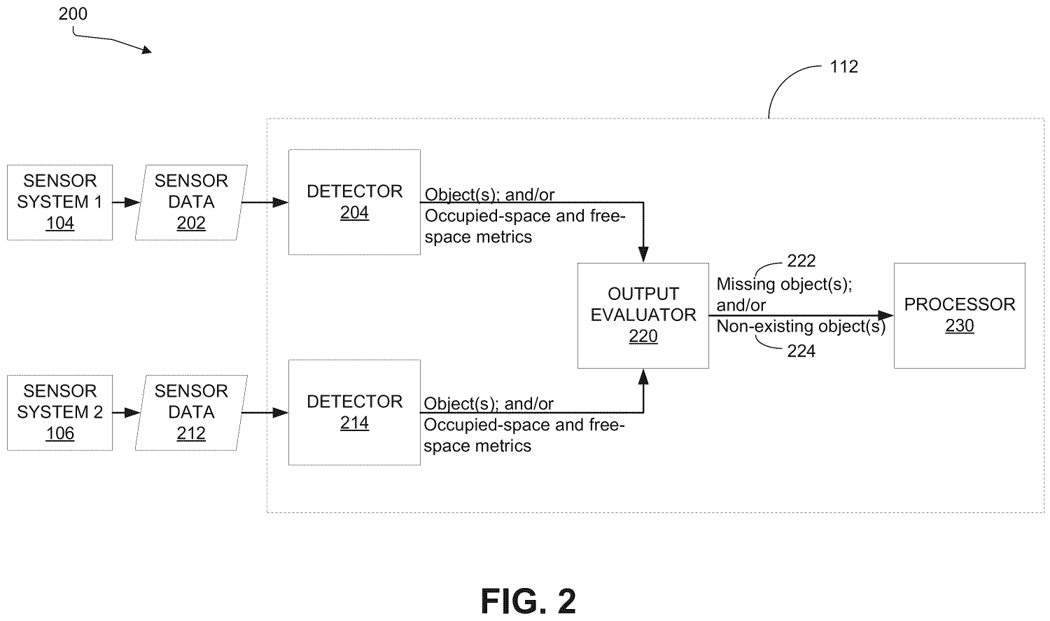

FIG. 2 illustrates an example pipeline 200 for utilizing occupied space and free space metrics for object detections. For example, example pipeline 200 shows an example of generating object detection(s) and occupied space and free space metrics based on sensor data from multiple sensors. In some cases, the multiple sensors (e.g., sensor systems 104, 106) used to obtain sensor data (e.g., sensor data 202, 212) in FIG. 2 can include multiple sensors of different modalities or multiple sensors of the same modality. In some cases, example pipeline 200 can be deployed in a perception system (e.g., perception stack 112) of an AV (e.g., AV 102) for accurate detections and understanding of the surrounding environment.

In some examples, each of sensor systems 104, 106 can collect sensor data 202, 212, respectively, and provide sensor data 202 and 212 to detectors 204 and 214, respectively. Each of sensor systems 104 and 106 can include any sensor system such as, for example and without limitation, a camera sensor, a LIDAR sensor, a RADAR sensor, a time-of-flight (TOF) sensor, an ultrasonic sensor, a wireless sensor, an infrared (IR) sensor, or any other applicable sensor. Non-limiting examples of each of sensor data 202, 212 can include image data (e.g., a still image, a video frame, etc.), a point cloud or point cloud data, one or more measurements, acoustic data, one or more frames, a sensor map (e.g., a depth map, a TOF sensor map, a heat map, etc.), an output signal (e.g., a RADAR signal, a distance or proximity sensor signal, etc.), a WIFI environment map (e.g., a WIFI heat map, etc.), a wave or pulse (e.g., a sound wave, etc.), a distance or proximity sensor output, an IR sensor output, or any other applicable sensor output.

In some cases, each detector 204, 214 can analyze and process the respective sensor data 202, 212 and detect an object(s) in the respective sensor data 202, 212 (e.g., depicted, measured, represented, described, contained, or reflected in the respective sensor data 202, 212). In some aspects, an object(s) can include any object with a geometric definition such as a footprint, a center, a width, a height, etc. Non-limiting examples of an object(s) that may be present in a scene can include a pedestrian, a vehicle, a bicycle, a motorcycle, an animal, a sign, a building, a tree, a road or traffic marking, a structure, a cone, a device, or any other object.

In some examples, detector 204, 214 can include any model (e.g., machine learning model or machine learning algorithm) configured to detect one or more objects in the respective sensor data 202, 212. For example, detector 204, 214 can perform segmentation to identify and/or distinguish between a portion(s) of the respective sensor data 202, 212 corresponding to a background and a portion(s) of the respective sensor data 202, 212 corresponding to the object(s) and/or a foreground that includes object(s). In some cases, detector 204, 214 can detect features in the respective sensor data 202, 212 corresponding to the object(s) and detect the object(s) based on the detected features. Detector 204, 214 can also optionally classify the features and/or the combination of features as corresponding to the object(s) and/or the type of object(s). In some cases, detector 204, 214 can generate a bounding box (or any other shape) identifying and/or outlining the region(s) and/or portion(s) of the respective sensor data 202, 212 that includes object(s). If sensor data 202, 212 includes image data, in some examples, detector 204, 214 can perform image processing to detect the object(s) within the image data.

In some examples, each detector 204, 214 can analyze and process the respective sensor data 202, 212 and generate occupied space and free space metrics. In some examples, each detector 204, 214 can generate probabilistic representations of an occupied space and a free space for each cell or point of the respective sensor data 202, 212, which can be presented in images such as a grid map. For example, an occupied space probability and a free space probability can be computed for each cell of the grid map representing the scene captured by sensor(s) of an AV (e.g., AV 102).

In some cases, an occupied space probability or a free space probability may be a top-down image with values in a range from 0 to 1. In some examples, an occupied space probability or a free space probability may be expressed in binary or Boolean values (e.g., true or false). For example, if sensor system 104 is a LiDAR sensor that collects sensor data 202, which is a three-dimensional (3D) point cloud of the environment, detector 204 may analyze the point cloud data to identify areas where there are no objects and assign a high free space probability to those areas. Also, detector 204 may analyze the point cloud data to identify areas where an object(s) exists and assign a high occupied space probability to those areas.

In another example, sensor system 106 can be a 3D camera sensor that collects sensor data 212, which includes a depth map of the environment. The depth map can assign a distance value to each pixel based on the perceived depth of the corresponding point in the scene. Detector 214 can analyze the depth map data and identify areas where there are no objects and assign a high free space probability to those areas. Also, detector 214 may analyze the depth map data and identify areas where an object(s) exists and assign a high occupied space probability to those areas.

Further, non-limiting examples of factors for determining an occupied space probability or a free space probability include geometric characteristics of an object (e.g., a size, a shape, a location, etc.), environmental factors (e.g., weather, lighting, interference from other sources, road features, etc.), speed or velocity of an object, characteristics of a sensor (e.g., sensitivity, resolution, range, etc.). In some aspects, the occupancy space and free space probabilities can be computed by using Artificial Neural Networks (ANNs) where each occupancy space and free space probability can be predicted using ANN inference. For example, the ANNs can be trained to predict whether each grid cell is occupied or free, which can lead to heatmaps for these quantities. In some examples, ANNs can be convolutional neural networks (CNN). Other Machine Learning or heuristic methods can also be used to do the same.

In some aspects, detector 204, 214 can provide information relating to the object detections and occupied space and free space metrics to output evaluator 220, which is configured to evaluate and/or compare the outputs from each detector 204, 214 and determine if there is any missing object(s) 222 and/or non-existing object(s) 224. For example, output evaluator 220 can determine if there is any conflicting information between output from detector 204 and output from detector 214 by comparing the occupied space and free space metrics against a predetermined threshold. The predetermined threshold may be chosen to optimize recall or precision (e.g., recall vs. precision). For example, a lower value can be chosen to favor more recall and less precision, while a higher value can be chosen to favor less recall and more precision. In some examples, a higher recall may be desired if the impact of missed occupied or free cells outweighs the impact of false occupied or free cells. The impact may be calculated over a set of scenarios based on the number of safety or comfort events that are introduced and removed due to the choice of the threshold. In some examples, safety events may include events that could result in collisions, near-collisions, or dangerous driving. In some examples, comfort events can include sudden swerving or braking, hard brakes, etc. This assessment may be conducted in the simulation as well as using supervised or unsupervised real driving scenarios.

In some examples, output evaluator 220 can compare the output from detector 204 (e.g., object(s) and/or occupied space and free space metrics) and output from detector 214 (e.g., object(s) and/or occupied space and free space metrics) by mapping the object detections from detector 204 onto an image that represents occupied space probability and free space probability to determine one or more cells (or pixels, datapoints, values) that may have conflicting output. For example, output evaluator 220 can determine one or more cells that have object(s) from detector 204. For those cells that have object(s) from detector 204 overlaid, output evaluator 220 can determine whether an occupied space probability from detector 214 is higher than an occupancy threshold. If the occupied space probability is higher than the occupancy space threshold on a cell, output evaluator 220 can mark the cell as a potential missing object.

In another example, output evaluator 220 can determine one or more cells that do not have object(s) from detector 204. For those cells that do not have object(s) from detector 214 overlaid, output evaluator 220 can determine whether a free space probability from detector 214 is higher than a free space threshold. If the free space probability is higher than the free space threshold on a cell, output evaluator 220 can mark the cell as a potential non-existing object.

In some aspects, output evaluator 220 can group the cell(s) that are indicative of a potential missing object(s) and measure an area of the cell(s) for each object. In some examples, output evaluator 220 can determine whether the area is larger than a missing object threshold. If the area is larger than the missing object threshold, output evaluator 220 can determine that there may be conflicting/inconsistent detection output between sensor systems 104, 106, which may be indicative of a missing object 222.

In some cases, output evaluator 220 can group the cell(s) that are indicative of a potential non-existing object(s) and measure an area of the cell(s) for each object. In some examples, output evaluator 220 can determine whether the area is larger than a non-existing object threshold. If the area is larger than the non-existing object threshold, output evaluator 220 can determine that there may be conflicting/inconsistent detection output between sensor systems 104, 106, which may be indicative of a non-existing object 224. For example, output evaluator 220 can generate non-existing object 224 by grouping, merging, or combining adjacent or neighboring cell(s) that are adjacent or neighboring that may correspond to non-existing object 224.

In some aspects, a missing object threshold and/or non-existing object threshold may vary depending on characteristics of the potential missing object or non-existing object (e.g., a type, size, dimension, etc.), environmental factors (e.g., weather, lighting condition, etc.), or scene features. For example, if the potential missing/non-existing object is predicted to be a construction cone, the threshold would be lower than the threshold for a building.

In some cases, output evaluator 220 can provide information relating to missing object(s) 222 and/or non-existing object(s) 224 to processor 230, which is configured to determine a remedial action with respect to missing object(s) 222 and/or non-existing object(s) 224. For missing object(s) 222, remedial actions can include, for example without limitation, regenerating sensor data 202, 204 with a modified configuration of sensor systems 104, 106 or a lower detection threshold, marking the area of missing object(s) 222 and avoiding the marked area during planning, simulating potential objects in the area of missing object(s) 222 to be used in planning, adding missing object(s) 222 as an object with a predetermined type and characteristics (e.g., a size, weight, width, height, dimension, speed, velocity, etc.), and adding missing object(s) as an object that has at least one property or characteristics similar to missing object(s) 222. For non-existing object(s) 224, remedial actions can include, for example, without limitation, removing non-existing object(s) 224, removing at least a portion of non-existing object(s) 224, or marking non-existing object(s) 224 as uncertain for planning (e.g., adjusting the weight of possible scenario hypothesis).

While processor 230 is illustrated as part of perception stack 112, processor 230 can also be a component of other applicable systems (e.g., planning stack 118, simulation platform 156, etc.) that may be configured to plan, initiate, and/or execute a remedial action with respect to missing object(s) 222 and/or non-existing object(s) 224. In some cases, process 230 can include one or more models and/or algorithms (e.g., prediction and/or planning algorithms used by an AV (e.g., AV 102) to perform one or more AV prediction and/or planning tasks, simulations, operations, calculations, etc.)

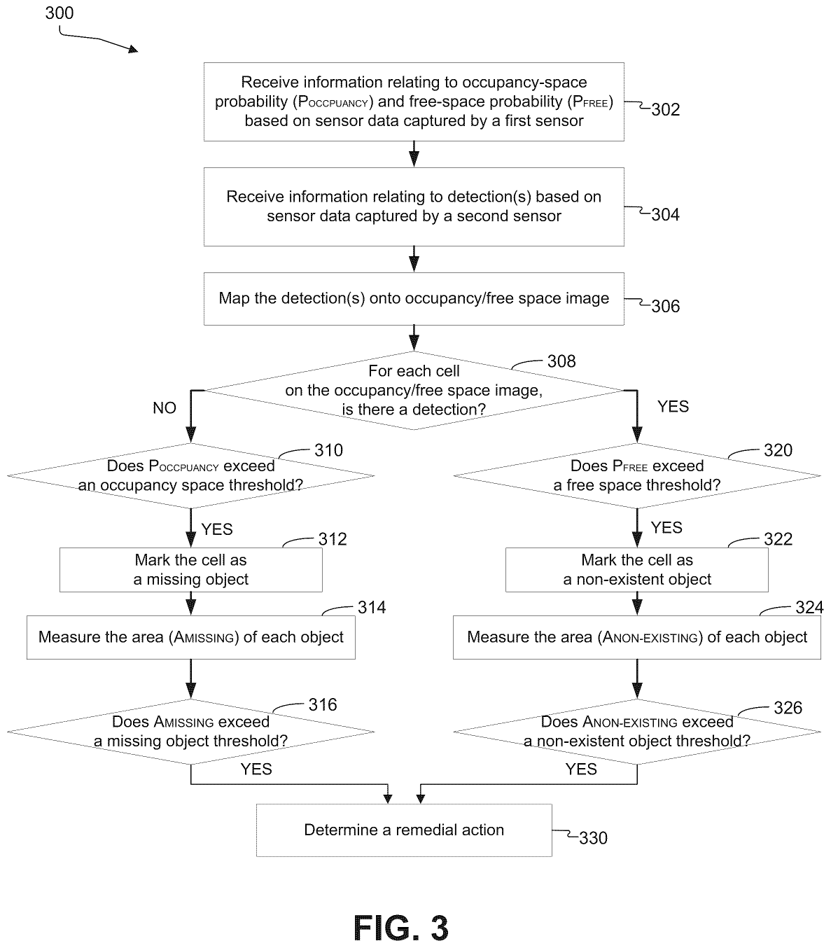

FIG. 3 is a flowchart illustrating an example process 300 for utilizing occupied space and free space metrics for object detections of a perception system, according to some examples of the present disclosure. In this example, process 300 shows utilizing occupied space and free space metrics and object detections from multiple sensors and/or sensor modalities to identify a missing object or non-existing object that may be resulted from inconsistencies between sensor data from multiple sensors and/or sensor modalities.

At step 302, process 300 includes receiving information relating to occupied space probability and free space probability based on sensor data captured by a first sensor. For example, the first sensor (e.g., sensor system 104 of AV 102) can collect sensor data 202 that is descriptive of the surrounding environment. Based on sensor data 202, the systems and techniques described herein (e.g., perception system or perception stack 112) can determine occupied space and free space metrics such as an occupied space probability (P_{OCCUPANCY}) and a free space probability (P_{FREE}).

At step 304, process 300 includes receiving information relating to object detection(s) based on sensor data captured by a second sensor. For example, the second sensor (e.g., sensor system 106 of AV 102) can collect sensor data 212 that is descriptive of the surrounding environment. Based on sensor data 212, the systems and techniques described herein can identify objects (e.g., object detections).

In some examples, process 300 may proceed to step 306, which may include mapping the detection(s) that are identified based on the sensor data captured by the second sensor onto occupancy space and/or free space image that depicts the same scene. For example, the systems and techniques described herein (e.g., perception stack 112) can map the object detections that are based on sensor data 212 onto an image (e.g., grid map) that represents the occupancy space probability and free space probability that are based on sensor data 202.

At step 308, process 300 includes determining whether there is a detection for each cell on the occupancy space and/or free space image. For example, for each cell (or pixel, datapoint, values) of an image (e.g., grid map) of the occupied space and free space metrics, the systems and techniques can determine where the overlaid detection(s) falls onto in the image.

In some cases, if a cell does not include at least a portion of the object that is detected based on sensor data 212, process 300 may proceed to step 310 and determine whether P_{OCCUPANCY} of the cell exceeds an occupancy space threshold. If P_{OCCUPANCY} of the cell exceeds the occupancy space threshold, process 300 may proceed to step 312, which includes marking the cell as a missing object.

In some cases, at step 314, process 300 can include measuring the area (A_{MISSING}) of each object (e.g., potential missing object). For example, the systems and techniques can group, merge, or combine cells that are neighboring or adjacent and may indicate the same object.

At step 316, process 300 can include determining whether A_{MISSING} of each object exceeds a missing object threshold. In some aspects, if A_{MISSING} exceeds the missing object threshold, process 300 may proceed to step 330 and determine a remedial action accordingly.

For example, the systems and techniques (e.g., perception stack 112) can re-run one or more detectors (e.g., detector 204, 214 as illustrated in FIG. 2) with a modified configuration. In another example, the systems and techniques (e.g., perception stack 112) can re-run one or more detectors (e.g., detector 204, 214 as illustrated in FIG. 2) with lower detection threshold. In another example, the systems and techniques (e.g., perception stack 112) can re-run one or more detectors (e.g., detector 204, 214 as illustrated in FIG. 2) with lower detection threshold with respect to the area associated with missing object(s) (e.g., missing object 222).

In some examples, remedial actions can include marking A_{MISSING} SO that a planning system (e.g., planning stack 118) can avoid the missing object. In some examples, the systems and techniques can initiate simulation (e.g., via simulation platform 156 as illustrated in FIG. 1) with the missing object placed in the scene. Also, the missing object added in the scene can be used for future hypotheses during planning. In some examples, the systems and techniques can add the missing object as an object of a predetermined type and characteristics (e.g., a size, dimension, speed, velocity, etc.) depending on the geometry, environmental factors, scene features, road features that are associated with the scene. In some examples, the systems and techniques can add the missing object as an object in the scene depending on the size of the cells that are indicative of the missing object (A_{MISSING}).

In some cases, if the perception system (e.g., perception stack 112) determines, at step 308 that a cell on the image include at least a portion of the object that is detected based on sensor data 212, process 300 may proceed to step 320, which includes determining whether P_{FREE} of the cell exceeds a free space threshold. If P_{FREE} of the cell exceeds the free space threshold, process 300 may proceed to step 322, which includes marking the cell as a non-existing object.

In some examples, at step 324, process 300 may include measuring the area (A_{NON-EXISTING}) of each object (e.g., potential non-existing object). For example, the systems and techniques can group, merge, or combine cells that are neighboring or adjacent to indicate the same object.

At step 326, process 300 includes determining whether A_{NON-EXISTING} of each object exceeds a non-existing object threshold. In some aspects, if A_{NON-EXISTING} exceeds the free space threshold, process 300 may proceed to step 330 and determine a remedial action accordingly. Non-limiting examples of remedial actions with respect to a non-existing object include removal of the non-existing object in the scene, removal of at least a portion of the non-existing object (e.g., a portion of the non-existing object that has conflicting data output between sensor data 202 and sensor data 212), and marking the non-existing object as uncertain so that a planning system (e.g., planning stack 118) may take the uncertain object into consideration in planning (e.g., adjusting the weight of possible scenario hypothesis).

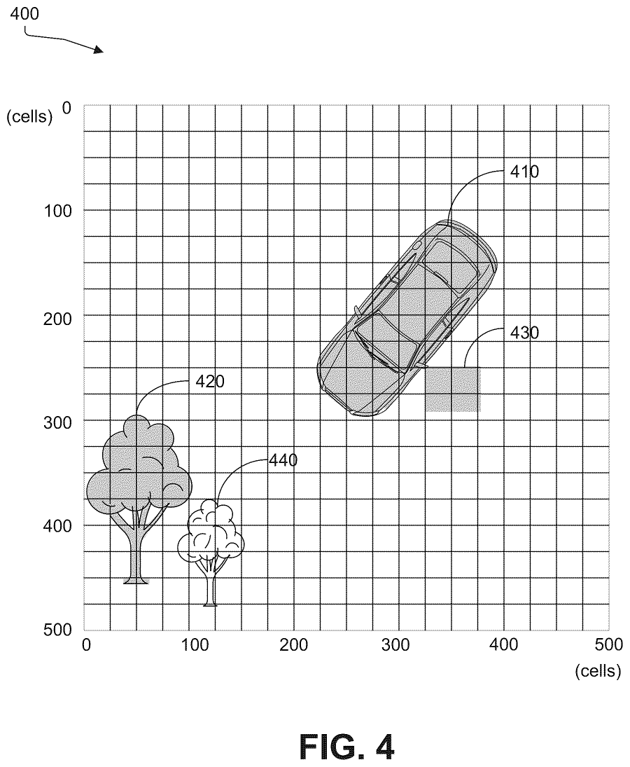

FIG. 4 illustrates an example grid map 400 of a scene captured by sensors. As previously described, a perception system (e.g., perception stack 112) can generate a grid map representing an occupied space and/or a free space metrics for each cell based on sensor data captured by a sensor (e.g., sensor system 104) of an AV (e.g., AV 102). Also, object(s) that are identified/detected based on sensor data captured by another sensor (e.g., sensor system 106) of an AV (e.g., AV 102) can be overlaid or mapped on the grid map of the occupancy space and/or a free space metrics.

In the illustrative example of FIG. 4, an occupancy space and free space metrics are represented in a grid format such that each cell is associated with a probability of occupancy or freeness. For ground truth that is used during ANN training, cells that contain any object can be marked based on the volume of occupancy. For example, if 50% of the cell is occupied in volume, it can be marked with a true occupancy value of 50%. The occupancy space and free space metrics are determined based on a first sensor (e.g., sensor system 104) of an AV (e.g., AV 102). Further, example grid map 400 includes objects (e.g., vehicle 410, tree 420, tree 440) that are detected based on sensor data captured by a second sensor (e.g., sensor system 108) of an AV (e.g., AV 102).

As shown, with respect to vehicle 410 and tree 420, data output (e.g., occupied space metrics) based on the first sensor (e.g., sensor system 104) is consistent with data output (e.g., object detection) based on the second sensor (e.g., sensor system 106). With respect to area 430, the systems and techniques described herein (e.g., perception stack 112) can determine whether the measured area of the colored cells of area 430 exceeds a missing object threshold. With respect to tree 440, the data output based on the second sensor (e.g., sensor system 108) includes tree 440. On the other hand, the occupancy space and/or free space metrics based on the first sensor (e.g., sensor system 104) indicate the absence of tree 440. As follows, the systems and techniques described herein can measure the area of tree 440 and determine whether the area exceeds a non-existing threshold.

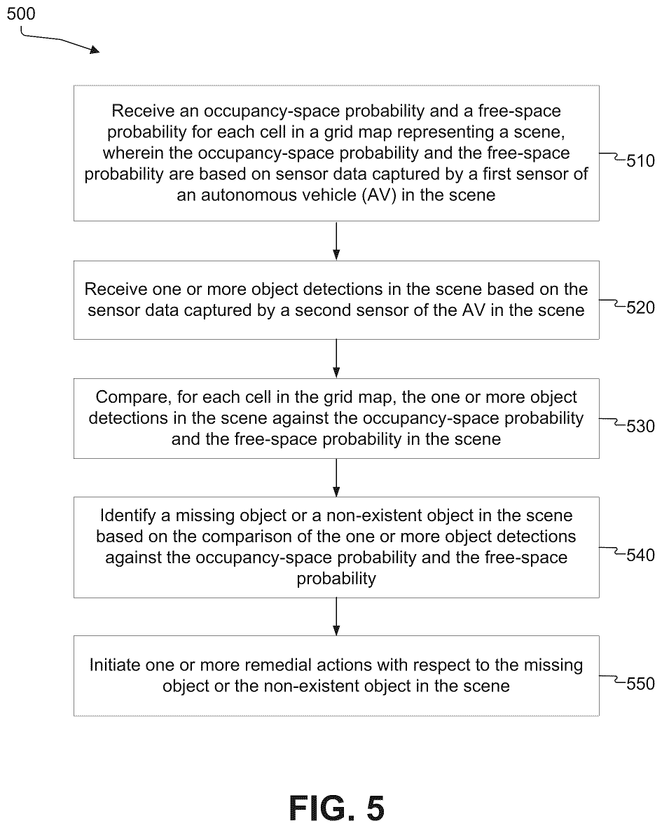

FIG. 5 is a flowchart illustrating an example process 500 for utilizing occupied space and free space metrics for object detections of a perception system. Although the example process 500 depicts a particular sequence of operations, the sequence may be altered without departing from the scope of the present disclosure. For example, some of the operations depicted may be performed in parallel or in a different sequence that does not materially affect the function of process 500. In other examples, different components of an example device or system that implements process 500 may perform functions at substantially the same time or in a specific sequence.

At block 510, process 500 includes receiving an occupancy-space probability and a free-space probability for each cell in a grid map representing a scene. The occupancy-space probability and the free-space probability are based on sensor data captured by a first sensor of an AV in the scene. For example, a perception system (e.g., perception stack 112) can receive information relating to occupancy-space and/or free-space metrics (e.g., an occupancy-space probability and a free-space probability) based on sensor data captured by a first sensor of an AV (e.g., AV 102) in the scene. In some examples, the occupancy-space and/or free-space metrics may be represented in a grid map where each cell of the grid map represents the occupancy-space probability and/or free-space probability.

At block 520, process 500 includes receiving one or more object detections in the scene based on the sensor data captured by a second sensor of the AV in the scene. For example, a perception system (e.g., perception stack 112) can receive one or more object detections in the scene based on the sensor data captured by a second sensor of the AV in the scene. In some cases, the first sensor and the second sensor can be multiple sensors of different modalities or multiple sensors of the same modality. For example, while the first sensor is a LiDAR sensor, the second sensor may be a camera sensor or vice versa.

At block 530, process 500 includes comparing, for each cell in the grid map, the one or more object detections in the scene against the occupancy-space probability and the free-space probability in the scene. For example, a perception system (e.g., perception stack 112) can compare, for each cell on an image (e.g., grid map) that represents the occupancy-space probability and the free-space probability, the one or more objects that are detected based on the sensor data from the second sensor against the occupancy-space probability and the free-space probability that are determined based on the sensor data from the first sensor. In some cases, the one or more object detections that are detected based on the sensor data from the sensor data can be mapped onto the grid map of the occupied space and free space metrics (e.g., grid map 400 as illustrated in FIG. 4).

At block 540, process 500 includes identifying a missing object or a non-existent object in the scene based on the comparison of the one or more object detections against the occupancy-space probability and the free-space probability. For example, a perception system (e.g., perception stack 112) can identify a missing object 222 and/or a non-existing object 224 based on the comparison of the one or more object detections that are based on sensor data of the first sensor against the occupancy-space probability and the free-space probability that are based on sensor data of the second sensor.

At block 550, process 500 includes initiating one or more remedial actions with respect to the missing object or the non-existent object in the scene. For example, a perception system (e.g., perception stack 112) may determine a remedial action with respect to the missing object 222 and/or the non-existing object 224. As described previously, the remedial action can be executed by perception stack 112, planning stack 118, simulation platform 156, or any other system that may be configured to perform the remedial action accordingly.

FIG. 6 illustrates an example processor-based system with which some aspects of the subject technology can be implemented. For example, processor-based system 600 can be any computing device making up local computing device 110, one or more computers of data center 150, a passenger device (e.g., client computing device 170) executing the ride-hailing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communication interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital

Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: receive an occupancy-space probability and a free-space probability for each cell in a grid map representing a scene, wherein the occupancy-space probability and the free-space probability are based on sensor data captured by a first sensor of an autonomous vehicle (AV) in the scene; receive one or more object detections in the scene based on the sensor data captured by a second sensor of the AV; compare, for each cell in the grid map, the one or more object detections in the scene against the occupancy-space probability and the free-space probability in the scene; identify a missing object or a non-existent object in the scene based on the comparison of the one or more object detections against the occupancy-space probability and the free-space probability; and initiate one or more remedial actions with respect to the missing object or the non-existent object in the scene.

Aspect 2. The system of Aspect 1, wherein to compare the one or more object detections in the scene against the occupancy-space probability and the free-space probability in the scene, the one or more processors are configured to: overlay the one or more object detections onto the grid map of the occupancy-space probability and the free-space probability.

Aspect 3. The system of Aspects 1 or 2, wherein to compare the occupancy-space probability and the free-space probability with the one or more object detections, the one or more processors are configured to: to determine that the cell indicates the missing object in response to a determination that the occupancy-space probability exceeds a threshold in a cell that has no object detection in the scene.

Aspect 4. The system of Aspect 3, wherein the one or more processors are configured to: group one or more cells that indicate the missing object; compare an area of the group of the one or more cells that indicate the missing object to an area threshold; and in response to a determination that the area of the group of the one or more cells that are indicative of the missing object exceeds the area threshold, initiate the one or more remedial actions with respect to the missing object.

Aspect 5. The system of any of Aspects 1 to 4, wherein comparing the occupancy-space probability and a free-space probability with the one or more object detections comprises: in response to a determination that the free-space probability exceeds a threshold in a cell that includes at least one object detection in the scene, determining that the cell indicates the non-existent object.

Aspect 6. The system of Aspect 5, wherein the one or more processors are configured to: group one or more cells that indicate the non-existent object; compare an area of the group of the one or more cells that indicate the non-existent object to an area threshold; and in response to a determination that the area of the group of the one or more cells that are indicative of the missing object exceeds the area threshold, initiate the one or more remedial actions with respect to the non-existent object.

Aspect 7. The system of any of Aspects 1 to 6, wherein the one or more remedial actions comprise: regenerating the sensor data captured by the first sensor or the second sensor of the AV in the scene.

Aspect 8. The system of any of Aspects 1 to 7, wherein the one or more remedial actions comprise: marking an area that consists of one or more cells that are indicative of the missing object to avoid during a planning of controlling the AV.

Aspect 9. The system of any of Aspects 1 to 8, wherein the one or more remedial actions comprise: simulating the scene with the missing object for a planning of controlling the AV.

Aspect 10. The system of any of Aspects 1 to 9, wherein the one or more remedial actions comprise: adding at least a portion of the missing object in the scene for a planning of controlling the AV.

Aspect 11. The system of any of Aspects 1 to 10, wherein the one or more remedial actions comprise: removing at least a portion of the non-existent object in the scene for a planning of controlling the AV.

Aspect 12. The system of any of Aspects 1 to 11, wherein the one or more remedial actions comprise: marking the non-existent object in the scene as uncertain for a planning of controlling the AV.

Aspect 13. The system of any of Aspects 1 to 12, wherein the one or more object detections include an object defined by a geometry of the object including at least one of a width, a depth, a height, and a footprint.

Aspect 14. A method comprising: receiving an occupancy-space probability and a free-space probability for each cell in a grid map representing a scene, wherein the occupancy-space probability and the free-space probability are based on sensor data captured by a first sensor of an autonomous vehicle (AV) in the scene; receiving one or more object detections in the scene based on the sensor data captured by a second sensor of the AV; comparing, for each cell in the grid map, the one or more object detections in the scene against the occupancy-space probability and the free-space probability in the scene; identifying a missing object or a non-existent object in the scene based on the comparison of the one or more object detections against the occupancy-space probability and the free-space probability; and initiating one or more remedial actions with respect to the missing object or the non-existent object in the scene.

Aspect 15. The method of Aspect 14, wherein comparing the one or more object detections against the occupancy-space probability and the free-space probability comprises: overlaying the one or more object detections onto the grid map of the occupancy-space probability and the free-space probability.

Aspect 16. The method of Aspects 14 or 15, wherein comparing the occupancy-space probability and the free-space probability with the one or more object detections comprises: determining that the cell indicates the missing object in response to a determination that the occupancy-space probability exceeds a threshold in a cell that has no object detection in the scene.

Aspect 17. The method of Aspect 16, further comprising: grouping one or more cells that indicate the missing object; comparing an area of the group of the one or more cells that indicate the missing object to an area threshold; and in response to a determination that the area of the group of the one or more cells that are indicative of the missing object exceeds the area threshold, initiating the one or more remedial actions with respect to the missing object.

Aspect 18. The method of any of Aspects 14 to 17, wherein comparing the occupancy-space probability and a free-space probability with the one or more object detections comprises: in response to a determination that the free-space probability exceeds a threshold in a cell that includes at least one object detection in the scene, determining that the cell indicates the non-existent object.

Aspect 19. The method of Aspect 18, further comprising: grouping one or more cells that indicate the non-existent object; comparing an area of the group of the one or more cells that indicate the non-existent object to an area threshold; and in response to a determination that the area of the group of the one or more cells that are indicative of the missing object exceeds the area threshold, initiating the one or more remedial actions with respect to the non-existent object.

Aspect 20. A non-transitory computer-readable medium having stored thereon instructions which, when executed by one or more processors, cause the one or more processors to perform method according to any of Aspects 14 to 19.

Aspect 21. An autonomous vehicle comprising a computer device having stored thereon instructions which, when executed by the computing device, cause the computing device to perform a method according to any of Aspects 14 to 19.

Aspect 22. A computer-program product comprising instructions which, when executed by one or more processors, cause the one or more processors to perform a method according to any of Aspects 14 to 19.

What is claimed is:

1. A system comprising:
a memory; and
one or more processors coupled to the memory, the one or more processors being configured to:
receive an occupancy-space probability and a free-space probability for each cell in a grid map representing a scene, wherein the occupancy-space probability and the free-space probability are based on sensor data captured by a first sensor of an autonomous vehicle (AV) in the scene;
receive one or more object detections in the scene based on the sensor data captured by a second sensor of the AV;
compare, for each cell in the grid map, the one or more object detections in the scene against the occupancy-space probability and the free-space probability in the scene;
identify a missing object or a non-existent object in the scene based on the comparison of the one or more object detections against the occupancy-space probability and the free-space probability; and
initiate one or more remedial actions with respect to the missing object or the non-existent object in the scene.

2. The system of claim 1, wherein to compare the one or more object detections in the scene against the occupancy-space probability and the free-space probability in the scene, the one or more processors are configured to:
overlay the one or more object detections onto the grid map of the occupancy-space probability and the free-space probability.

3. The system of claim 1, wherein to compare the occupancy-space probability and the free-space probability with the one or more object detections, the one or more processors are configured to:
to determine that the cell indicates the missing object in response to a determination that the occupancy-space probability exceeds a threshold in a cell that has no object detection in the scene.

4. The system of claim 3, wherein the one or more processors are configured to:
group one or more cells that indicate the missing object;
compare an area of the group of the one or more cells that indicate the missing object to an area threshold; and
in response to a determination that the area of the group of the one or more cells that are indicative of the missing object exceeds the area threshold, initiate the one or more remedial actions with respect to the missing object.

5. The system of claim 1, wherein comparing the occupancy-space probability and a free-space probability with the one or more object detections comprises:
in response to a determination that the free-space probability exceeds a threshold in a cell that includes at least one object detection in the scene, determining that the cell indicates the non-existent object.

6. The system of claim 5, wherein the one or more processors are configured to:
group one or more cells that indicate the non-existent object;
compare an area of the group of the one or more cells that indicate the non-existent object to an area threshold; and
in response to a determination that the area of the group of the one or more cells that are indicative of the missing object exceeds the area threshold, initiate the one or more remedial actions with respect to the non-existent object.

7. The system of claim 1, wherein the one or more remedial actions comprise:
regenerating the sensor data captured by the first sensor or the second sensor of the AV in the scene.

8. The system of claim 1, wherein the one or more remedial actions comprise:
marking an area that consists of one or more cells that are indicative of the missing object to avoid during a planning of controlling the AV.

9. The system of claim 1, wherein the one or more remedial actions comprise:
simulating the scene with the missing object for a planning of controlling the AV.

10. The system of claim 1, wherein the one or more remedial actions comprise:
adding at least a portion of the missing object in the scene for a planning of controlling the AV.

11. The system of claim 1, wherein the one or more remedial actions comprise:
removing at least a portion of the non-existent object in the scene for a planning of controlling the AV.

12. The system of claim 1, wherein the one or more remedial actions comprise:
marking the non-existent object in the scene as uncertain for a planning of controlling the AV.

13. The system of claim 1, wherein the one or more object detections include an object defined by a geometry of the object including at least one of a width, a depth, a height, and a footprint.

14. A method comprising:
receiving an occupancy-space probability and a free-space probability for each cell in a grid map representing a scene, wherein the occupancy-space probability and the free-space probability are based on sensor data captured by a first sensor of an autonomous vehicle (AV) in the scene;
receiving one or more object detections in the scene based on the sensor data captured by a second sensor of the AV;
comparing, for each cell in the grid map, the one or more object detections in the scene against the occupancy-space probability and the free-space probability in the scene;
identifying a missing object or a non-existent object in the scene based on the comparison of the one or more object detections against the occupancy-space probability and the free-space probability; and
initiating one or more remedial actions with respect to the missing object or the non-existent object in the scene.

15. The method of claim 14, wherein comparing the one or more object detections against the occupancy-space probability and the free-space probability comprises:
overlaying the one or more object detections onto the grid map of the occupancy-space probability and the free-space probability.

16. The method of claim 14, wherein comparing the occupancy-space probability and the free-space probability with the one or more object detections comprises:
determining that the cell indicates the missing object in response to a determination that the occupancy-space probability exceeds a threshold in a cell that has no object detection in the scene.

17. The method of claim 16, further comprising:
grouping one or more cells that indicate the missing object;
comparing an area of the group of the one or more cells that indicate the missing object to an area threshold; and
in response to a determination that the area of the group of the one or more cells that are indicative of the missing object exceeds the area threshold, initiating the one or more remedial actions with respect to the missing object.

18. The method of claim 14, wherein comparing the occupancy-space probability and a free-space probability with the one or more object detections comprises:
in response to a determination that the free-space probability exceeds a threshold in a cell that includes at least one object detection in the scene, determining that the cell indicates the non-existent object.

19. The method of claim 18, further comprising:
grouping one or more cells that indicate the non-existent object;
comparing an area of the group of the one or more cells that indicate the non-existent object to an area threshold; and
in response to a determination that the area of the group of the one or more cells that are indicative of the missing object exceeds the area threshold, initiating the one or more remedial actions with respect to the non-existent object.

20. A non-transitory computer-readable medium having stored thereon instructions which, when executed by one or more processors, cause the one or more processors to:
receive an occupancy-space probability and a free-space probability for each cell in a grid map representing a scene, wherein the occupancy-space probability and the free-space probability are based on sensor data captured by a first sensor of an autonomous vehicle (AV) in the scene;
receive one or more object detections in the scene based on the sensor data captured by a second sensor of the AV;
compare, for each cell in the grid map, the one or more object detections in the scene against the occupancy-space probability and the free-space probability in the scene;
identify a missing object or a non-existent object in the scene based on the comparison of the one or more object detections against the occupancy-space probability and the free-space probability; and
initiate one or more remedial actions with respect to the missing object or the non-existent object in the scene.
